(19) United States
(12) Patent Application Publication
(10) Pub. No.: US 2023/0228990 A1
(43) Pub. Date: Jul. 20, 2023

(54) WEARABLE DEVICE AND METHOD OF PROJECTION

(71) Applicant: Chun-Ding HUANG, Taipei City (TW)

(72) Inventor: Chun-Ding HUANG, Taipei City (TW)

(21) Appl. No.: 18/154,044

(22) Filed: Jan. 13, 2023

(30) Foreign Application Priority Data
Jan. 20, 2022 (TW) 111102468

(51) Int. Cl. G02B 27/00; G02B 27/01

(52) U.S. Cl. CPC G02B 27/0093; G02B 27/0179; G02B 27/0176; G02B 27/0172; G02B 2027/0187; G02B 2027/0178

(57) ABSTRACT

A wearable device is configured to be worn on a head of a user. The wearable device includes a sensing module and an image forming module. The sensing module is configured to sense an intersection of sight lines of two eyes of the user. The image forming module is coupled with the sensing module. The image forming module is configured to project a pattern onto one of the two eyes of the user, such that the pattern is visually located at a first position at which the intersection of sight lines locates.

### RELATED APPLICATIONS

This application claims priority to Taiwanese Application Serial Number 111102468 filed Jan. 20, 2022, which is herein incorporated by reference.

### BACKGROUND

### Technical Field

The present disclosure relates to wearable devices. More particularly, the present disclosure relates to wearable devices which can assist users to suppress nystagmus.

### Description of Related Art

With the increase of ages, human eyeballs may experience involuntary tremors due to aging and cannot effectively focus on an object or switch lines of sight. Therefore, the visual clarity will be affected. Furthermore, the ability to visually perceive depth may become worse and the situation of hand-eye incoordination may occur.

Involuntary eye tremors can cause the elderly to spend more time focusing on objects or writings. In addition, when switching sight lines, the elderly may feel uncomfortable because the intersection of the sight lines of the two eyes cannot be aligned, which will affect the hand-eye coordination, and even affect the ability to move or cause accidents and injuries in life.

Hence, how to propose a method or device that can solve the problems above is one of the problems that the industry is eager to devote resources of research and development to solve.

### SUMMARY

A technical aspect of the present disclosure is to provide a wearable device, which can solve the problems mentioned above.

According to an embodiment of the present disclosure, a wearable device is configured to be worn on a head of a user. The wearable device includes a sensing module and an image forming module. The sensing module is configured to sense an intersection of sight lines of two eyes of the user. The image forming module is coupled with the sensing module. The image forming module is configured to project a pattern onto one of the two eyes of the user, such that the pattern is visually located at a first position at which the intersection of sight lines locates.

In one or more embodiments of the present disclosure, when the sensing module further senses a rotation of one of the two eyes of the user, the image forming module stops projecting the pattern.

In one or more embodiments of the present disclosure, when the sensing module senses a movement of the intersection of sight lines from the first position to a second position, the image forming module further moves visually the pattern from the first position to the second position.

In one or more embodiments of the present disclosure, when the sensing module further senses a movement of the intersection of sight lines, the image forming module further moves visually the pattern to follow the intersection of sight lines.

In one or more embodiments of the present disclosure, the wearable device further includes a position sensor. The position sensor is configured to sense a rotation of the head of the user. When the position sensor senses the rotation of the head of the user by more than an angular velocity threshold, the image forming module stops projecting the pattern.

In one or more embodiments of the present disclosure, the position sensor is a gyroscope.

In one or more embodiments of the present disclosure, the sensing module includes at least one high-speed camera. The high-speed camera is configured to capture the intersection of sight lines.

In one or more embodiments of the present disclosure, the image forming module includes a retinal imaging display (RID).

In one or more embodiments of the present disclosure, the image forming module includes an augmented reality (AR).

In one or more embodiments of the present disclosure, the image forming module includes an eye movement sensor. The eye movement sensor is configured to sense a rotation of the intersection of sight lines.

In one or more embodiments of the present disclosure, the image forming module includes an accelerometer. The accelerometer is configured to sense a movement of the head of the user.

According to another embodiment of the present disclosure, a method of projection includes: sensing an intersection of sight lines of two eyes of a user; and projecting a pattern onto one of the two eyes, such that the pattern is visually located at a first position at which the intersection of sight lines locates.

In one or more embodiments of the present disclosure, the method further includes: stopping projecting the pattern when sensing a rotation of one of the two eyes of the user.

In one or more embodiments of the present disclosure, the method further includes: when sensing a movement of the intersection of sight lines from the first position to a second position, further moving visually the pattern from the first position to the second position.

In one or more embodiments of the present disclosure, the method further includes: when further sensing a movement of the intersection of sight lines, further moving visually the pattern to follow the intersection of sight lines.

In one or more embodiments of the present disclosure, the method further includes: stopping projecting the pattern when sensing a rotation of the head of the user by more than an angular velocity threshold.

The above-mentioned embodiments of the present disclosure have at least the following advantages: by using the wearable device and the method of projection provided in the present disclosure, when looking at stationary objects, moving objects or switching between the objects to be seen, the image forming module in the wearable device can be used to carry out a projection of the object, allowing the user to be assisted visually by the pattern projected, which suppresses the brain from affecting the eyeballs to produce involuntary tremors, so as to enhance the visual depth and improve the hand-eye coordination during movement of the user.

### BRIEF DESCRIPTION OF THE DRAWINGS

The disclosure can be more fully understood by reading the following detailed description of the embodiments, with reference made to the accompanying drawings as follows:

FIG. 1A is a schematic view of a wearable device according to an embodiment of the present disclosure, in which the wearable device is worn by a user;

FIG. 1B is a schematic view of a wearable device according to another embodiment of the present disclosure, in which the wearable device is worn by a user;

FIG. 2 is a schematic view of a wearable device according to an embodiment of the present disclosure, in which a user focuses on an object through the wearable device;

FIG. 3 is a schematic view of a wearable device according to an embodiment of the present disclosure, in which a user switches his focus from an object to another object through the wearable device;

FIG. 4 is a schematic view of a wearable device according to an embodiment of the present disclosure, in which a user focuses on a movement of an object through the wearable device; and

FIGS. 5A-5F are flow charts of operations in a method of projection according to a plurality of embodiments of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

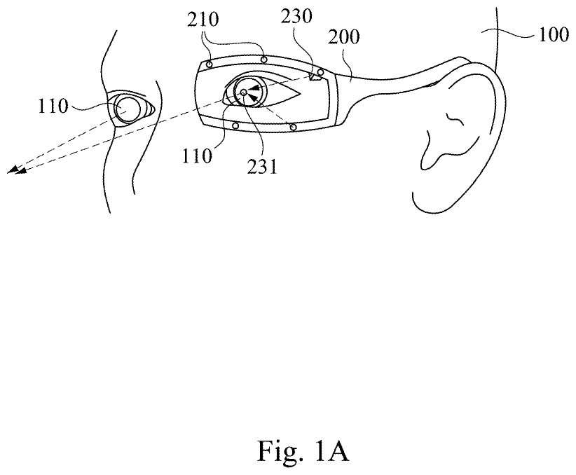

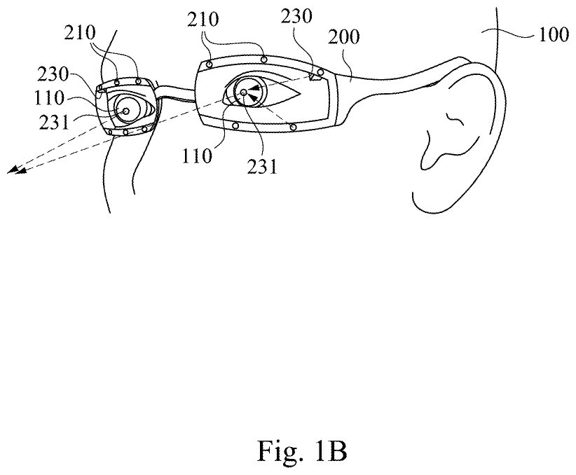

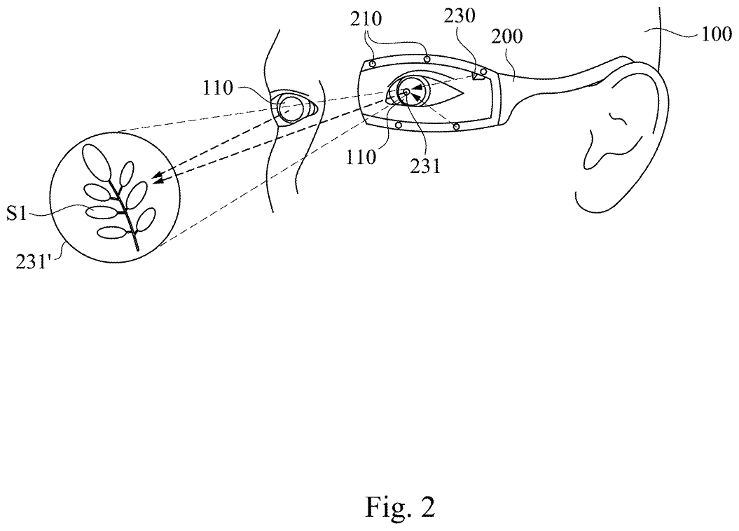

Reference is made to FIG. 1A and FIG. 2. FIG. 1A is a schematic view of a wearable device 200 according to an embodiment of the present disclosure, in which the wearable device 200 is worn by a user 100. FIG. 2 is a schematic view of a wearable device 200 according to an embodiment of the present disclosure, in which a user 100 focuses on an object S1 through the wearable device 200. In an embodiment of the present disclosure, the wearable device 200 is configured to be worn on the head of a user 100. The wearable device 200 includes a sensing module 210 and an image forming module 230. The sensing module 210 is configured to sense an intersection of sight lines of two eyes 110 of the user 100. The image forming module 230 is coupled with the sensing module 210. The image forming module 230 is configured to project a pattern 231 onto one of the two eyes 110 of the user 100, and an image 231′ is then produced at the position of the intersection of sight lines, such that the pattern 231 is visually located at the position of the intersection of sight lines. The pattern 231 is not limited to the circular frame shown in the figure. The details are described below.

To be specific, when the user 100 focuses on an object S1, the intersection of sight lines overlaps with the positon of the object S1. At this point, since the image forming module 230 projects the pattern 231 onto at least one of the two eyes 110, and a corresponding image 231′ is then produced at the position of the intersection of sight lines or the region indicating the coverage of intersection of sight lines. Thus, the pattern 231 is visually located at the position of the object S1 (for example, the framed object S1 may at least partially overlap with the object S1). The production of the corresponding image 231′ through the projection of the pattern 231 can assist the user 100 to align the intersection of sight lines with the position of the object S1. The prompt of the pattern 231 can avoid the brain of the user 100 from affecting the two eyes 110 to produce involuntary tremors, thereby assisting the user 100 to focus on the object S1 when stationary or moving.

In one or a plurality of embodiment(s) in the present disclosure, the appearance of the wearable device 200 can be a single-eyed glasses (please refer to FIG. 1A), a double-eyed glasses (please refer to FIG. 1B) or any object or device which can be fixed to the head of the user 100. The wearable device 200 can be a smart glasses (such as Microsoft HoloLens 2) sold by Microsoft Corporation. The user 100 can adjust the shape, size or detailed structure of the wearable device 200 according to the actual situation, and this does not intend to limit the present disclosure. The sensing module 210 can include one or a plurality of high-speed camera(s) to capture the intersection of sight lines of the two eyes 110. When the appearance of the wearable device 200 is a single-eyed glasses, one or a plurality of high-speed camera(s) can be disposed to match with the position of the two eyes 110. For example, when the user 100 wears the wearable device 200 as a single-eyed glasses at the left eye of the two eyes 110, the sensing module 210 includes a plurality of high-speed cameras respectively sensing the intersection of sight lines of the two eyes 110. One or a plurality of high-speed camera(s) can be disposed at a position close to the right eye, which facilitates to sense the sight line of the right eye. Moreover, this does not intend to limit the present disclosure, and positions of the sensing module 210 or the high-speed camera(s) can be adjusted according to the actual situation. The image forming module 230 can include a retinal imaging display (RID) or an augmented reality (AR), and this does not intend to limit the present disclosure. Moreover, the image forming module 230 further includes a processor, a controller or other computing device with computing functions, which is coupled with the sensing module 210 and can be matched with a software, a firmware or other hardware to assist to receive or compute the sensing signal emitted by the sensing module 210, and further send a control signal to drive the image forming module 230 to project the pattern 231 onto the two eyes 110 after receiving the sensing signal, thus accomplishing the present disclosure.

For example, the sensing module 210 senses the intersection of sight lines at which the user 100 focuses on the object S1 to produce a sensing signal. The processor carries out computation and produces a control signal after receiving the sensing signal to drive the image forming module 230 to project the pattern 231 onto the two eyes 110, and a corresponding image 231′ is then produced at the position of the intersection of sight lines or the region indicating the coverage of intersection of sight lines, such that the pattern 231 is visually located at the position of the intersection of sight lines (for example, the framed object S1 may at least partially overlap with the object S1). In this way, at the moment the user 100 is looking at the object S1, the pattern 231 is visually located at the position of the object S1, which suppresses the brain from affecting the eyes 110 to produce involuntary tremors, thereby assisting the user 100 to focus on the object S1 when stationary or moving.

In one or a plurality of embodiment(s) in the present disclosure, the pattern 231 and its image 231′ can be monochromatic, polychromatic or translucent, with a shape of triangle, rectangle, ellipse, circle or other polygons. Moreover, the pattern 231 can also be a triangular frame, a rectangular frame, a circular frame or other polygonal frames, and this does not intend to limit the present disclosure. When the pattern 231 is approximately of a circular shape or a circular frame, the deformation in the visual view will be relatively small, and the burden on the vision will be relatively light. In practice, the shape and color of the pattern 231 can be adjusted according to the situation or the surrounding environment.

Reference is made to FIG. 1B. FIG. 1B is a schematic view of a wearable device 200 according to another embodiment of the present disclosure, in which the wearable device 200 is worn by a user 100. In one or a plurality of embodiment(s) in the present disclosure, the image forming module 230 projects a pattern 231 onto the two eyes 110 of the user 100. The user 100 can practice with the alignment of the pattern 231 in the visual view, and the practice allows the intersection of sight lines to be located at the position of the object S1, which helps the user 100 to rehabilitate to alleviate the nystagmus caused by aging and assists the user 100 to stabilize the image 231′ of the object S1 focused by the sight lines.

In one or a plurality of embodiment(s) in the present disclosure, after the image forming module 230 projects a pattern 231 onto at least one of the two eyes 110, and the pattern 231 is visually located at the position of the object S1 (for example, the framed object S1 may at least partially overlap with the object S1), and when the user 100 looks away and does not continue to focus on the object S1, the sensing module 210 further senses a rotation of at least one or both of the two eyes 110 of the user 100. At this point, the sensing module 210 sends a sensing signal to the image forming module 230 to stop projecting the pattern 231, so as to avoid the pattern 231 from remaining at the scope of the visual view of the user 100, which may otherwise affect the vision.

In one or a plurality of embodiment(s) in the present disclosure, a time threshold can also be set. After the image forming module 230 projects the pattern 231 onto at least one or both of the two eyes 110, when the duration of projecting the pattern 231 reaches the time threshold, the image forming module 230 stops projecting the pattern 231 in order to avoid the pattern 231 from remaining visually at the scope of the visual view of the user 100, which may otherwise affect the vision. The time threshold can be 0.5 sec, 1 sec, 1.5 sec, 2 sec or other length of duration, and can be adjusted according to the actual situation, which does not intend to limit the present disclosure.

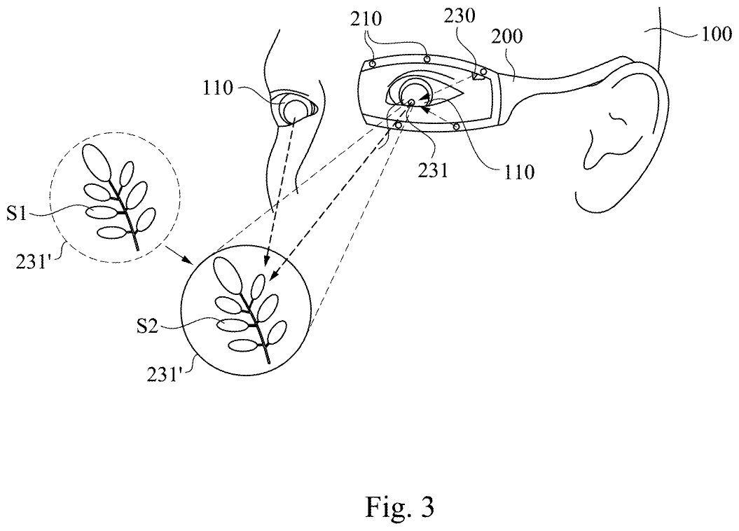

Reference is made to FIG. 3. FIG. 3 is a schematic view of a wearable device 200 according to an embodiment of the present disclosure, in which a user 100 switches his focus from an object S1 to another object S2 through the wearable device 200. In one or a plurality of embodiment(s) in the present disclosure, when the sensing module 210 senses that the intersection of sight lines moves from the position of the original object S1 to the position of another object S2, the corresponding image 231′ produced also moves from the position of object S1 to the position of the object S2. Thus, the image forming module 230 further allows the pattern 231 to move visually from the position of the original object S1 to the position of another object S2. The pattern 231 follows the intersection of sight lines to move visually from the object S1 to the object S2, which can assist the user 100 to switch the sight lines from focusing on the object S1 to focusing on the object S2, which then alleviates the involuntary tremor produced by the two eyes 110 to reduce the discomfort of looking away caused by aging. The object S1 and the object S2 are not limited to specific objects here, and are merely used to briefly describe two different objects, so as to explain the situations of movement or switch of the intersection of sight lines. The “movement” of the pattern 231 can refer to continuous movement of the pattern 231 in a visual manner, and can also refer to the disappearance of the pattern 231 from an original position and the reappearance at another position separated by a certain distance, but this does not intend to limit the present disclosure and can be adjusted according to the environment where the user 100 is present and the type of the object S1 or the object S2 to be looked at. The time interval between the disappearance and reappearance of the pattern 231 can be 0.5 sec, 1 sec, 1.5 sec, 2 sec or other length of duration, and this does not intend to limit the present disclosure.

For example, after the sensing module 210 senses that the user 100 looks at the object S1 and the pattern 231 is visually located at the position of the object S1, and when the two eyes 110 turn to look at another object S2, the sensing module 210 senses that the user 100 moves the intersection of sight lines to the position of the object S2 and then produces a sensing signal. The image forming module 230 projects the pattern 231 onto at least one or both of the two eyes 110 after the sensing signal is received through the processor, and a corresponding image 231′ is then produced which moves to follow the intersection of sight lines, such that the pattern 231 follows the intersection of sight lines and moves visually to the position of the object S2 (which means the pattern 231 moves visually from the position of the object S1 to the position of the object S2).

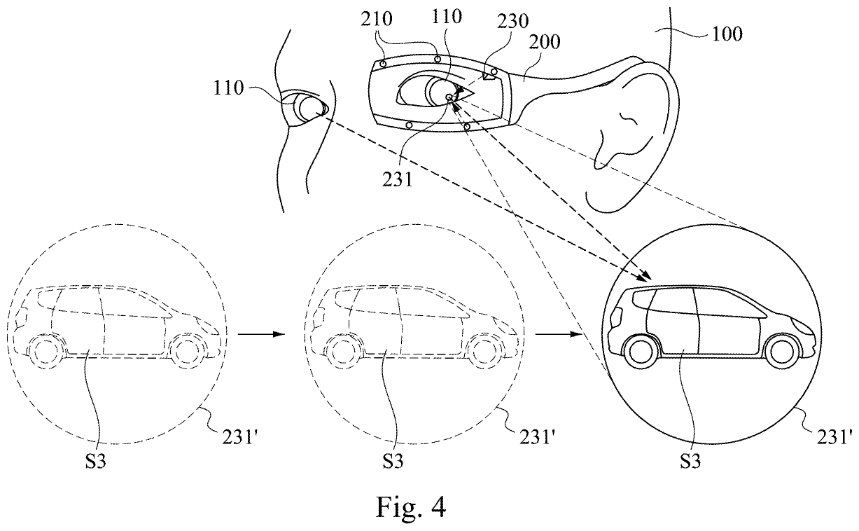

Reference is made to FIG. 4. FIG. 4 is a schematic view of a wearable device 200 according to an embodiment of the present disclosure, in which a user 100 focuses on a movement of an object S3 through the wearable device 200. In one or a plurality of embodiment(s) in the present disclosure, when the user 100 looks at the movement of the object S3, and the sensing module 210 senses that the intersection of sight lines moves to follow the position of the object S3, the image forming module 230 further produces a corresponding image 231′ according to the projection of the pattern 231 and the image 231′ moves to follow the position of the object S3, such that the pattern 231 moves visually to follow the object S3. In this embodiment, through the projection of the pattern 231 onto at least one or both of the two eyes 110, the user 100 is assisted to look at the movement of the object S3, which alleviates the discomfort of switching the sight lines when looking at moving object S3.

To be specific, when the two eyes 110 keep looking at the object S3 such that the intersection of sight lines moves with the movement of the object S3, the sensing module 210 senses the movement of the intersection of sight lines and keeps sending sensing signals. The image forming module 230 receives the sensing signals through the processor and produces the image 231′ which moves with the position of the object S3, so as to control the pattern 231 to moves visually to follow the object S3.

In one or a plurality of embodiment(s) in the present disclosure, the image forming module 230 includes a position sensor and an eye movement sensor. The position sensor is configured to sense a rotation of the head of the user 100. The eye movement sensor is configured to sense a rotation of the intersection of sight lines, which is caused by the rotation of the head or a rotation of the eyeballs of the user 100. When the position sensor senses the rotation of the head of the user 100 to be more than an angular velocity threshold, the image forming module 230 stops projecting the pattern 231. In this embodiment, the position sensor can be a gyroscope. However, this does not intend to limit the present disclosure. The angular velocity threshold can be 30 degrees per second, 45 degrees per second or 60 degrees per second, and this does not intend to limit the present disclosure. On the other hand, an angular acceleration sensor can be used to replace the position sensor. When it is sensed that the rotation of the head is more than a preset value of the angular acceleration threshold, the image forming module 230 stops projecting the pattern 231.

In other embodiments of the present disclosure, the image forming module 230 includes an accelerometer, which is configured to sense a movement of the head of the user 100. When the accelerometer senses the movement of the head of the user 100 to be more than a preset value of the acceleration threshold, the image forming module 230 stops projecting the pattern 231.

As mentioned above, since the head movement will cause the change of visual field, the position sensor, the angular acceleration sensor or the accelerometer can immediately drive the image forming module 230 to stop projecting the pattern 231 when it senses that the head rotates too much or too fast, which can avoid the visual burden of the user 100 caused by the pattern 231 visually remaining in the visual field. In addition, the image forming module 230 can also, at the same time, include two or three of the position sensor, the angular acceleration sensor and the accelerometer, so that the user 100 can drive the image forming module 230 to immediately stop projecting the pattern 231 under a variety of conditions.

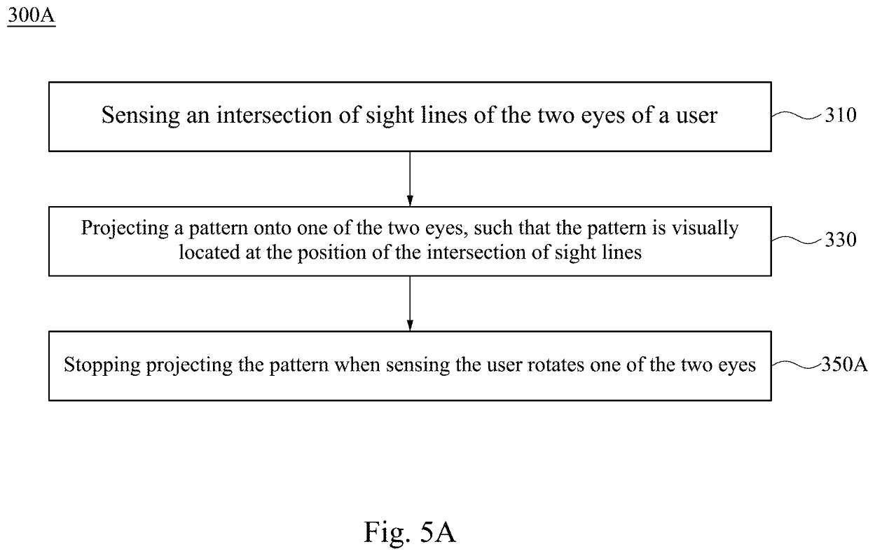

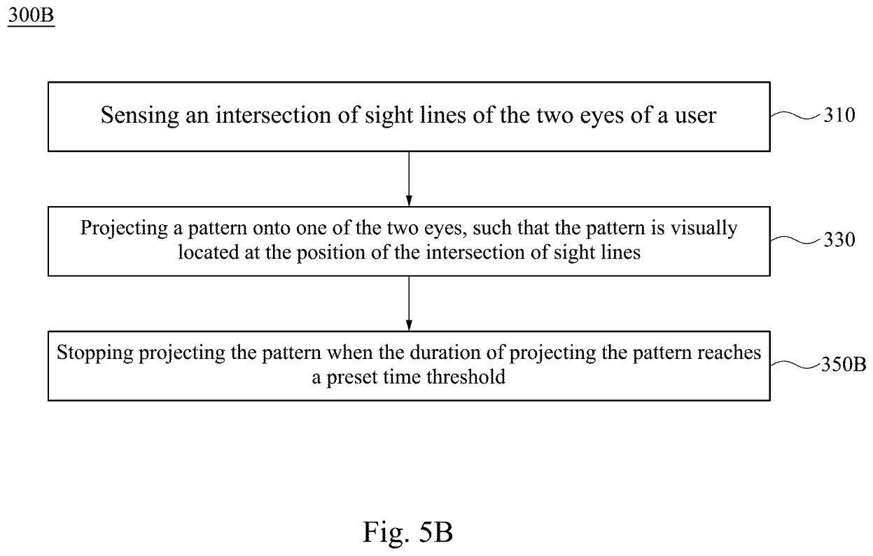

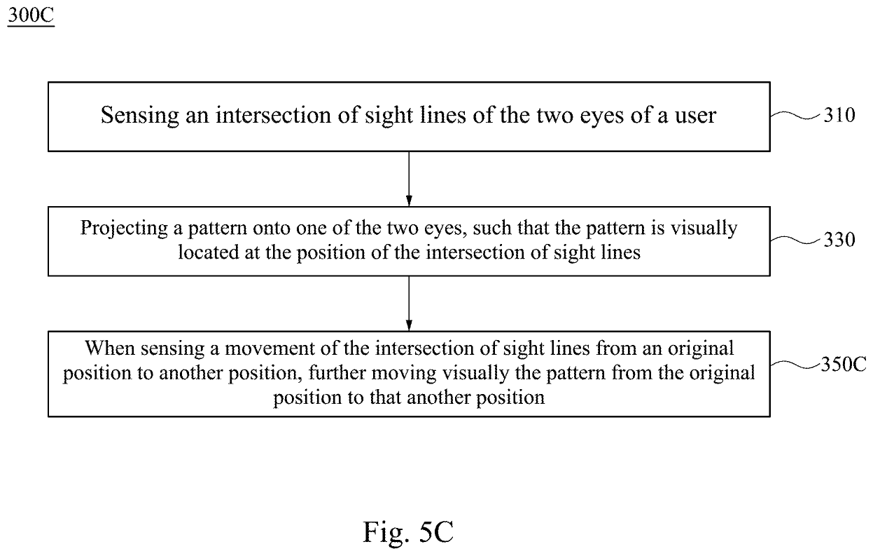

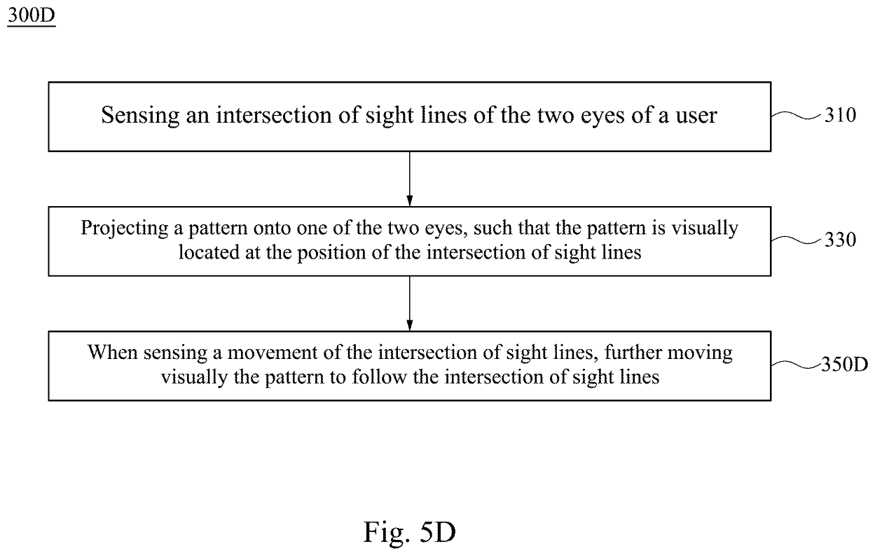

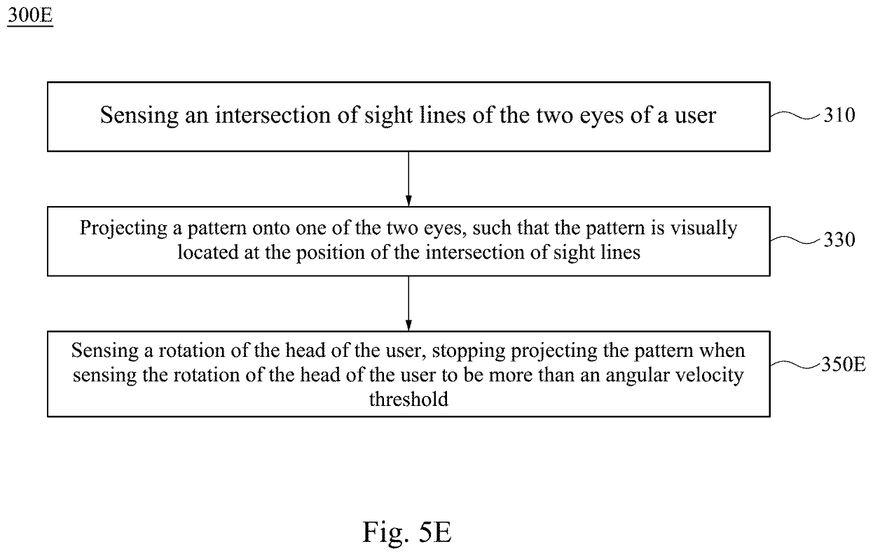

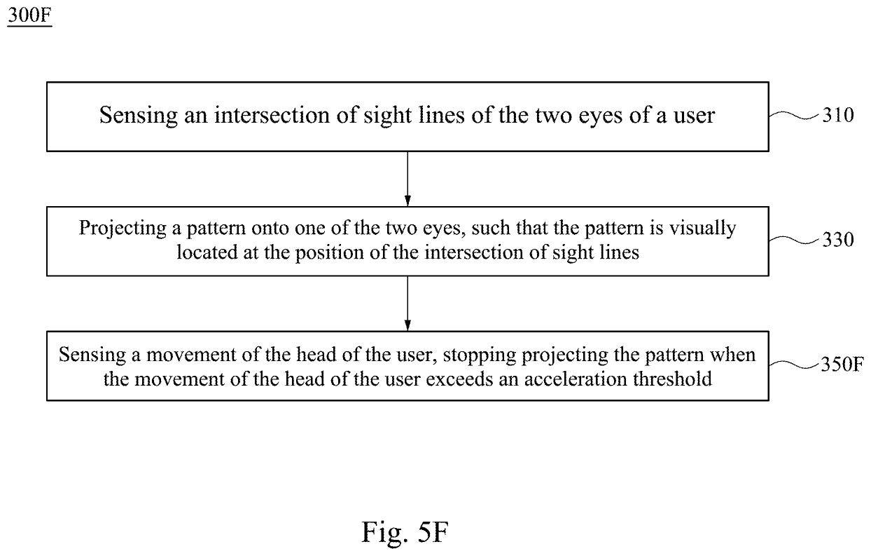

Reference is made to FIG. 5A. In the embodiment of FIG. 5A, the method of projection 300A includes an operation 310 and an operation 330. The operation 310: sensing the intersection of sight lines of the two eyes of the user. The operation 330: projecting the pattern onto at least one or both of the two eyes, such that the pattern is visually located at the position of the intersection of sight lines. In the operation 310, the sensing module having the high-speed camera can be used to sense the intersection of sight lines of the two eyes of the user. In the operation 330, the image forming module having a retinal imaging display or having an augmented reality can be used to project the pattern. Other details have been fully described above, and are not repeated here. People having original skill in the art can make judgments with reference to the contents mentioned above, and implement them accordingly.

In one or a plurality of embodiment(s) in the present disclosure, the method of projection 300A further includes an operation 350A: stopping projecting the pattern when sensing the user rotates at least one or both of the two eyes. The details in the operation 350A have been fully described above, and are not repeated here. After the method of projection 300A is ended at the operation 350A, it can go back to the operation 310 to start the execution, and then keep assisting the user to focus on other objects.

Reference is made to FIG. 5B. In the embodiment of FIG. 5B, the method of projection 300B replaces the operation 350A of the method of projection 300A by an operation 350B. The difference between the method of projection 300A and the method of projection 300B is the operation 350A and the operation 350B. The operation 350B is: stopping projecting the pattern when the duration of projecting the pattern reaches the time threshold. In the operation 350B, the time threshold can be preset to be 0.5 sec, 1 sec, 1.5 sec, 2 sec or other length of duration, and can be adjusted according to the actual situation, which does not intend to limit the present disclosure. Other details have been fully described above, and are not repeated here. After the method of projection 300B is ended at the operation 350B, it can go back to the operation 310 to start the execution, and then keep assisting the user to focus on other objects.

Reference is made to FIG. 5C. The difference between the method of projection 3000 in FIG. 5C and the embodiments previously mentioned is the operation 350C. The operation 350C is: when sensing a movement of the intersection of sight lines from an original position to another position, further moving visually the pattern from the original position to that another position. In the operation 350C, when the user switches between the objects to be seen, the sensing module can sense the movement of the intersection of sight lines from the position of an object to the position of another object, and the pattern in the visual manner of the user moves from the position of the original object to the position of another object, which assists the user to switch between the objects to be seen, and suppresses involuntary tremors of the eyeballs. The operation 350C can be repeatedly executed, in order to keep assisting the user to switch between the objects to be seen. Other details in the operation 350C have been fully described above, and are not repeated here.

Reference is made to FIG. 5D. The difference between the method of projection 300D in FIG. 5D and the embodiments previously mentioned is the operation 350D. The operation 350D is: when further sensing a movement of the intersection of sight lines, further moving visually the pattern to follow the intersection of sight lines. In the operation 350D, the intersection of sight lines of the user follows naturally the movement of the position of an object. Through projecting a pattern onto at least one or both of the two eyes of the user, and producing an image which follows the position of the intersection of sight lines, the pattern moves visually to follow the object, which can assist the user to look at the movement of the object and suppress involuntary tremors of the eyeballs. Other details in the operation 350D have been fully described above, and are not repeated here.

Reference is made to FIG. 5E. The difference between the method of projection 300E in FIG. 5E and the embodiments previously mentioned is the operation 350E. The operation 350E is: sensing a rotation of the head of the user, stopping projecting the pattern when sensing the rotation of the head of the user to be more than an angular velocity threshold. In the operation 530E, a position sensor (such as a gyroscope) can be used to sense the rotation of the head. When it is sensed that the rotation of the head is too much, the projection of the pattern onto the two eyes is immediately stopped, which avoids the visual burden of the user caused by the remaining pattern in the visual field. An angular acceleration sensor can be used to replace the position sensor. When it is sensed that the rotation of the head is more than an angular acceleration threshold, the projection of the pattern is stopped. After the method of projection 300E is ended at the operation 350E, it can go back to the operation 310 to start the execution, and then keep assisting the user to focus on other objects. Other details in the operation 350E have been fully described above, and are not repeated here.

Reference is made to FIG. 5F. The difference between the method of projection 300F in FIG. 5F and the embodiments previously mentioned is the operation 350F. The operation 350F is: sensing a movement of the head of the user, stopping projecting the pattern when the movement of the head of the user exceeds the acceleration threshold. In the operation 350F, an accelerometer can be used to sense the movement of the head. When the head moves too fast, the projection of pattern onto the two eyes is immediately stopped, which avoids the visual burden of the user caused by the remaining pattern in the visual field. After the method of projection 300F is ended at the operation 350F, it can go back to the operation 310 to start the execution, and then keep assisting the user to focus on other objects. Other details in the operation 350F have been fully described above, and are not repeated here.

In one or a plurality of embodiment(s) in the present disclosure, some of the operations mentioned above can be adjusted or combined according to the actual situations. For example, after the operation 350C of the method of projection 3000 is carried out, the operation 350B, the operation 350E or the operation 350F can be further executed. In other words, after the pattern is moved visually from the position of the original object to the position of another object, the operation 350A, the operation 350B, the operation 350E or the operation 350F can be further executed according to the actual situations, which stops the projection of pattern in order to avoid the visual burden of the user caused by the remaining pattern in the visual field for too long.

In other embodiments, after the operation 350D of the method of projection 300D is carried out, the operation 350A, the operation 350B, the operation 350E or the operation 350F can be further executed. In other words, when the pattern moves visually to follow the object, the operation 350B, the operation 350E or the operation 350F can be further executed according to the actual situations, which avoids the visual burden caused by the remaining pattern in the visual view for too long when it is unnecessary.

In conclusion, by using the wearable device and the method of projection provided in the present disclosure, when looking at stationary objects, moving objects or switching between the objects to be seen, the image forming module in the wearable device can be used to carry out a projection of the object, allowing the user to be assisted visually by the pattern projected, which suppresses the brain from affecting the eyeballs to produce involuntary tremors, so as to enhance the visual depth and improve the hand-eye coordination during movement of the user.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A wearable device, configured to be worn on a head of a user, comprising:
a sensing module configured to sense an intersection of sight lines of two eyes of the user; and
an image forming module coupled with the sensing module, the image forming module being configured to project a pattern onto one of the two eyes of the user, such that the pattern is visually located at a first position at which the intersection of sight lines locates.

2. The wearable device of claim 1, wherein when the sensing module further senses a rotation of one of the two eyes of the user, the image forming module stops projecting the pattern.

3. The wearable device of claim 1, wherein when the sensing module senses a movement of the intersection of sight lines from the first position to a second position, the image forming module further moves visually the pattern from the first position to the second position.

4. The wearable device of claim 1, wherein when the sensing module further senses a movement of the intersection of sight lines, the image forming module further moves visually the pattern to follow the intersection of sight lines.

5. The wearable device of claim 1, further comprising a position sensor configured to sense a rotation of the head of the user, wherein when the position sensor senses the rotation of the head of the user by more than an angular velocity threshold, the image forming module stops projecting the pattern.

6. The wearable device of claim 5, wherein the position sensor is a gyroscope.

7. The wearable device of claim 1, wherein the sensing module comprises at least one high-speed camera configured to capture the intersection of sight lines.

8. The wearable device of claim 1, wherein the image forming module comprises a retinal imaging display (RID).

9. The wearable device of claim 1, wherein the image forming module comprises an augmented reality (AR).

10. The wearable device of claim 1, wherein the image forming module comprises an eye movement sensor configured to sense a rotation of the intersection of sight lines.

11. The wearable device of claim 1, wherein the image forming module comprises an accelerometer configured to sense a movement of the head of the user.

12. A method of projection, comprising:
sensing an intersection of sight lines of two eyes of a user; and
projecting a pattern onto one of the two eyes, such that the pattern is visually located at a first position at which the intersection of sight lines locates.

13. The method of claim 12, further comprising:
stopping projecting the pattern when sensing a rotation of one of the two eyes of the user.

14. The method of claim 12, further comprising:
when sensing a movement of the intersection of sight lines from the first position to a second position, further moving visually the pattern from the first position to the second position.

15. The method of claim 12, further comprising:
when further sensing a movement of the intersection of sight lines, further moving visually the pattern to follow the intersection of sight lines.

16. The method of claim 12, further comprising:
stopping projecting the pattern when sensing a rotation of the head of the user by more than an angular velocity threshold.
